(19) United States
(12) Patent Application Publication
(10) Pub. No.: US 2006/0279481 A1
(43) Pub. Date: Dec. 14, 2006

(54) Image displaying apparatus

(76) Inventors: Fumio Haruna, Yokohama (JP); Toshimitsu Watanabe, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/367,691

(22) Filed: Mar. 6, 2006

(30) Foreign Application Priority Data
May 26, 2005 (JP) 2005-153260

(51) Int. Cl. G09G 3/28

(52) U.S. Cl. 345/63

(57) ABSTRACT

An image displaying apparatus, comprises: a plural number of electron sources, being disposed in matrix-like manner, each for emitting electrons therefrom; a driver for producing drive voltage for driving the electron sources upon basis of a video signal, to be supplied to the electron sources; and a correct circuit for correcting the video signal, wherein the correct circuit determines a predetermined number of correction points in horizontal and vertical directions, for the plural number of electron sources disposed in the matrix-like manner, corrects the video signal to the electron source corresponding to the correction point upon basis of a first correction value, which is determined in advance, and corrects the video signal corresponding to the electron source located between the correction points, upon basis of a second correction value, which is obtained through an interpolation calculation with using said first correction values, which are determined at each of the correction points, thereby correcting or compensating the unevenness in brightness, with using a small number of correction values therein.

### BACKGROUND OF THE INVENTION

1. Field of the Invention

The present invention relates to a technology for correcting quality of a picture, in particular, on a matrix-type image displaying apparatus of applying an electron-discharging element therein, such as, a thin-film electron source, for example; i.e., a Field Emission Display (hereinafter, being abbreviated by “FED”).

2. Description of the Related Art(s)

The FED comprises a plural number of electron sources, which are disposed in a matrix-like, and the each electron source emits electrons through application of driving voltage applied thereon, depending on an image or video signal. With this, an image can be formed on a display surface of the FED.

With the FED having such structures, there are cases where the electron sources differ in the electric characteristics thereof from one another, depending upon the manufacturing processes thereof. Namely, dispersion is caused in an amount of electrons emitted from each of the electron sources within the display surface, and this brings about lacking of uniformity among the pixels. A technology for correcting this dispersion in the brightness among the pixels on a panel driver circuit is disclosed in Japanese Patent Laying-Open No. Hei 7-181911 (1995), for example. In this prior art, it is described that an amount of electron emission for one (1) piece of the pixels is detected in the form of an anode current, so as to produce a correction value for each of the electron sources to be memorized, and that with using of this is controlled an amplitude or a pulse width of driving voltage to be applied onto each of the electron sources, so that the dispersion in each of the electron sources can be reduced.

### BRIEF SUMMARY OF THE INVENTION

However, the anode current for one (1) pixel (i.e., one (1) piece of electron source) is actually very small (in a degree of about 1 μA), and for this reason, an error comes to be large in the detection thereof. Also, when detecting the anode current for each one (1) pixel, a large amount of time is necessary. For example, in a case where a panel is of the VGA size (640×480), since one (1) horizontal period (i.e., 31.7 μs) is necessary, at least, for measuring one (1) piece of the pixel one (1) time, then the time, 640×480×(3 colors)×31.7 μs=29.2 seconds, is necessary. Further, for the purpose of increasing the accuracy of correction/measurement, it is necessary to make measurement on an mount of electron emission for one (1) pixel, by N(N≧2) times. In this case, time N×29.2 seconds comes to be necessary.

Namely, with the conventional art mentioned above, a large amount of time is necessary, so as to obtain the correction values for dealing with each of the electron sources. Also, the correction values must be memorized corresponding to all of the electron sources, and therefore a large amount of memory capacity is necessary, too.

An object according to the present invention, therefore, is to provide a technology for enabling to display a picture of high quality, reducing the unevenness in brightness, through correcting the unevenness in brightness of the electron sources.

An image displaying apparatus, according to the present invention, comprises a correct circuit, which is improved. Thus, the correct circuit, according to the present invention, determines correction points at a period of N pieces in the horizontal direction and a period M pieces in the vertical direction, for a plural number of electron sources, which are disposed in a matrix-like manner. It corrects the video signal corresponding to the electron source determined to be the correction point, upon basis of a first correction value, which is determined in advance. And, it corrects the video signal corresponding to the electron source located between the correction points, upon basis of a second correction value, which is obtained from the first correction values, each determined at the correction pint, through an interpolation calculation thereof.

The said second correction value may be obtained form two (2) pieces of the first correction values through a linear interpolation thereof, or it may be obtained from those first correction values through calculating a non-linear interpolation thereof. It is preferable to determine the correction points mentioned above equal to ten (10) or more in the number thereof.

With such the structures as was mentioned above, the video signal corresponding to the electron source, which is determined to be the correction point, is corrected by the first correction value memorized, while the video signal(s) other than that is/are corrected by the second correction value, which is obtained from the memorized correction value through calculation thereof. Accordingly, with the structures according to the present invention, it is sufficient to determine the correction values, not for all the electron sources, but only corresponding to the number of pieces of the correction points; therefore, the time for measuring an amount of electron emission for obtaining the correction value can be reduced. Also, since there is no need of memorizing the correction values to correct the unevenness or dispersion of each the electron source, for the entire electron sources, therefore a capacity can be reduced for a memory.

According to the present invention, it is possible to correct the dispersion in brightness of the electron sources, preferably, and thereby enabling to obtain a display of high quality with reducing the unevenness in the brightness thereof.

### BRIEF DESCRIPTION OF THE DRAWINGS

Those and other objects, features and advantages of the present invention will become more readily apparent from the following detailed description when taken in conjunction with the accompanying drawings wherein:

FIG. 1 is a block diagram for showing a first embodiment of the image displaying apparatus, according to the present invention;

FIG. 2 is a view for showing an example of a characteristic between a video signal and an amount of electron emission (i.e., video signal-electron emission amount characteristic) of an electron source;

FIGS. 3(a) to 3(c) are views for explaining a method for interpolating a correction value, according to the first embodiment;

FIG. 4 is also a view for explaining the method for interpolating the correction value, according to the first embodiment;

FIG. 5 is a block diagram for showing an example of a brightness dispersion correct circuit 8 shown in FIG. 1;

FIG. 6 is a view for showing an example of display of a pattern measured, according to the first embodiment;

FIG. 7 is a block diagram for showing a concrete example of an interpolation circuit 80 shown in FIG. 5;

FIGS. 8(a) and 8(b) are views for explaining the operation of a latch circuit 31 shown in FIG. 7;

FIG. 9 is a view for explaining the operations of linear interpolation circuits 20a, 20b and 20c shown in FIG. 7;

FIG. 10 is a block diagram for showing a second embodiment of the image displaying apparatus, according to the present invention;

FIG. 11 is a view for showing an example of the video signal-electron emission amount characteristic of an electron source;

FIG. 12 is also a view for showing an example of the video signal-electron emission amount characteristic of an electron source;

FIGS. 13 is a view for explaining a method for interpolating a correction value, according to the second embodiment;

FIG. 14 is also a view for explaining the method for interpolating the correction value, according to the second embodiment; and

FIGS. 15(a) and 15(b) are views for explaining about the video signal after correction thereof, according to the first and second embodiments.

### DETAILED DESCRIPTION OF THE PREFERRED EMBODIMENT

Hereinafter, embodiments according to the present invention will be fully explained by referring to the attached drawings.

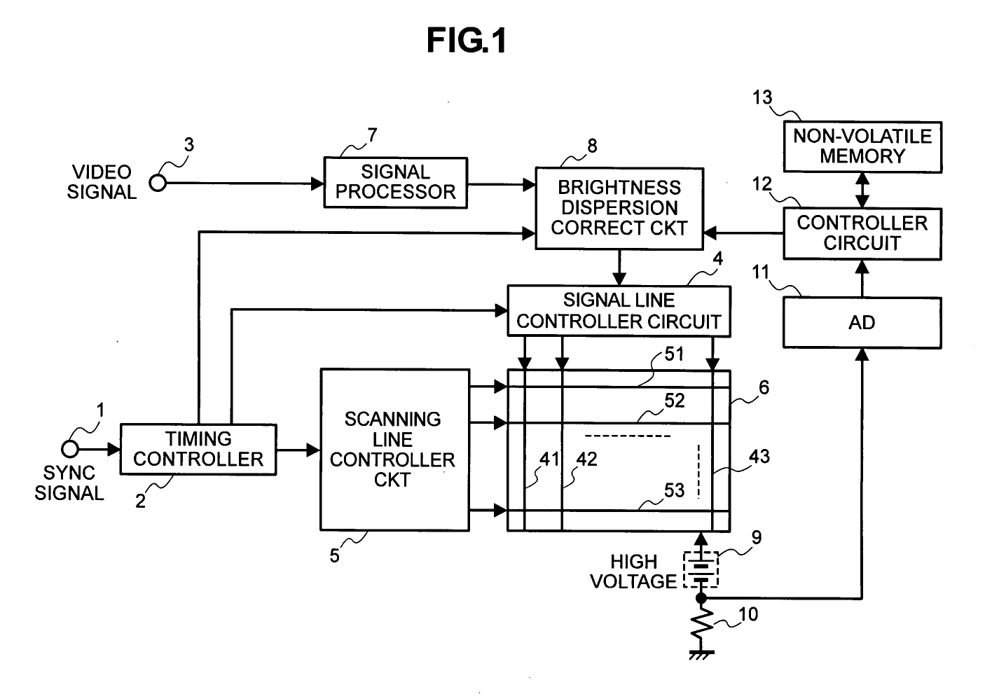

FIG. 1 shows a first embodiment of a FED-type image displaying apparatus, according to the present invention. However, in the present embodiment, explanation will be made upon an example of the FED-type image displaying apparatus of a passive matrix driving method, having electron sources of MIM (Metal-Insulator-Metal) type. However, according to the present invention, electron sources other than the MIM may be applied therein, for example, a surface conduction type (SCE), a carbon nano-tube type (CNT), a ballistic electron surface discharge type (BSD), and a Spindt type, in a similar manner. Also, within the present embodiment, explanation will be made on a case where a scanning line controller circuit 5 is provided only on one side of scanning lines. However, it is needless to say that the present invention may be applied in a case where the scanning line controller circuits 5 are provided on both ends of the scanning lines.

An image or video signal is inputted onto a video signal input terminal 3, and it is supplied into a signal processor circuit 7. Within the signal processor circuit 7, conducting the resolution conversion for fitting the video signal to the resolution of a display panel 6, but other than that, adjustments on the picture quality are also conducted therein, fitting to a taste or desire of a user, for example, the contrast, the brightness, the gamma (γ) correction, etc. Next, it is supplied into a brightness dispersion correct circuit 8, wherein correction is made on the dispersion of brightness within a surface of the display panel 6. The details of this correct circuit 8 will be explained, separately.

A synchronizing signal (or sync signal) corresponding to the video signal mentioned above is inputted into a sync signal input terminal 1, and it is supplied into a timing controller 2. In the timing controller 2, a timing pulse is generated in synchronism with the sync signal, to be supplied into the scanning line controller circuit 5 and a signal line controller circuit 4.

On the other hand, in the display panel 6 are disposed a plural number of scanning lines 51-53, in parallel with the vertical direction of the screen, and further disposed a plural number of signal lines 41-43, in parallel with the horizontal line of the screen. Those scanning lines 51-53 and the signal lines 41-43 come across with each other at right angles, and at each of intersecting points thereof is disposed an electron source (i.e., an electron emitting element), respectively, which is connected to each of the scanning lines and each of the signal lines.

The scanning lines 51-53 are connected to the scanning line controller circuit 5, at the left-hand side edges thereof. This scanning line controller circuit 5 supplies scanning voltages onto the scanning lines 51-53, for selecting the scanning lines by one (1) piece or every two (2) pieces thereof, in synchronism with a signal of the horizontal period supplied from the timing controller 2. Thus, the scanning line controller circuit 5 carries out the vertical scanning, while selecting the electron sources. by (1) line or every two (2) lines thereof at the horizontal period from the top thereof.

The signal lines 41-43 are connected the signal line controller circuit 4, i.e., a signal voltage supply circuit, at the upper ends thereof. The signal line controller circuit 4 supplied signal voltages corresponding to each of the signal lines (i.e., the electron sources), upon basis of the video signal supplied from the brightness dispersion correct circuit 8.

When the signal voltage is supplied from the signal line controller circuit 4 to each of the electron sources, which are connected to the scanning line(s), which is/are selected by the scanning voltage, at each of the electron sources is generated a potential difference (hereinafter, “driving voltage”) between the scanning voltage and the signal voltage. When this driving voltage exceeds a predetermined threshold value, the electron source emits electrons therefrom. An amount of electron emission from this electron source is in approximately proportional to the potential difference, in case when the potential difference is equal or larger than the threshold value. However, in case when the signal voltage is positive in the polarity thereof, the scanning voltage in negative in the polarity thereof, and when the signal voltage is in the negative polarity, then the scanning voltage is in the positive polarity. At the position opposite to each of the electron sources, there are provided a fluorescent substance and an accelerator electrode, which are not shown in the figures. Also, the space defined between the electron source and the fluorescent substance is kept under the vacuum atmosphere. And, the electrons emitted from the electron source are accelerated through high voltage, which is supplied from a high-voltage controller circuit 9 to the accelerator electrode, and travel within the vacuum to excite the fluorescent substance, thereby causing light irradiation. The lights irradiated are emitted into an outside through a transparent glass substrate not shown in the figure, and form a picture in the display panel 6.

Next, detailed explanation will be made on the operation of the brightness dispersion correct circuit 8.

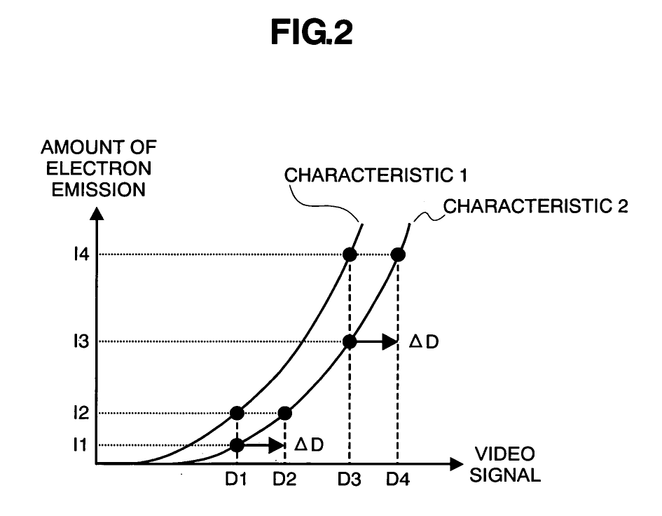

First, explanation will be given about the brightness dispersion within a surface of a FED. As was mentioned previously, unevenness is generated in the manufacturing process of the FED, in particular, in element characteristics, such as, element resistance values of the electron sources, etc., for example, and due to this, the brightness dispersion is generated. FIG. 2 shows the characteristics of an amount of electron emission with respect to the level of the video signal, about the two (2) pieces of electron sources, which are located at different positions. Though the electron source emits electrons when the video signal exceeds the predetermined threshold value, however there occur sometimes cases where the two (2) pieces of electron sources differ from each other in the threshold values thereof between them, due to the unevenness in the element characteristics thereof. Hereinafter, this threshold value is called by “electron emission start voltage”. Since this amount of electrons emission is in proportional to the luminous brightness, then there occurs a phenomenon that the brightness differs from each other even when applying the same video signal voltage onto to two (2) pieces of the electron sources. However, this phenomenon occurs only when the electron sources are separated from each other in the positions thereof, but the characteristic, i.e., the video signal versus the amount of electron emission, is nearly equal for the electron sources neighboring with each other. It can be considered that various kinds of characteristics, such as, the element resistance value and so on, depend on width and/or thickness of the physical wiring, or purity of an element material, etc. And, it can be inferred that the characteristic of electron emission does not change so much due to the relative coincidences of those, for the elements neighboring with each other.

The present invention utilizes such the characteristics of electron emission. Thus, according to the present invention, not providing the correction values of correcting brightness for all of the electron sources, respectively, but the correction value is provided in the following manner. First of all, the plural numbers of electron sources are divided in the horizontal and the vertical directions, i.e., into a plural number of blocks. And, the correction values are determined or set at the intersecting points of dividing lines, which are drawn (imaginarily) in the horizontal and the vertical directions for dividing the electron sources into the plural number of blocks; i.e., only four (4) corners of the each block. Further, in relation to the electron sources lying between the four (4) corners, new correction values are produced through the data interpolation using the correction values at the four corners thereof. Thus, according to the present embodiment, regarding the video signals, corresponding to the four (4) corners of the block mentioned above (i.e., the video signals, being the basis of the drive signal to be supplied to those electron sources), they are corrected with using a first correction value, which is preset in advance, and regarding the video signals, corresponding to the electron sources other than those at the four (4) corners, they are corrected with using a second correction value, which is obtained from the first correction value through the data interpolation thereof. This interpolation of the correction value employs the characteristic that the amounts of electron emission are nearly equal among the electron sources neighboring with each other. Preferably, the sizes of the block mentioned above are determined to be equal to or smaller than that of the period of change in the electron emission characteristics, over all of the electron sources. For example, consideration is made on a case where the brightness is changed in the horizontal direction and the vertical direction due to the unevenness or dispersion of the electron emission characteristic among the electron sources, in particular, when displaying an image having a constant gradation (for example, an image of only a gray color on a whole surface) on a whole display surface of the FED panel. In this instance, the straight lines connecting points changing in the brightness in the horizontal direction or the vertical direction is determined to be equal to the length of one (1) side of the each block mentioned above, or the length of one (1) side of the each block is determined to be shorter than that straight line. The sizes of the block, in other words, the number of division thereof is determined in this manner.

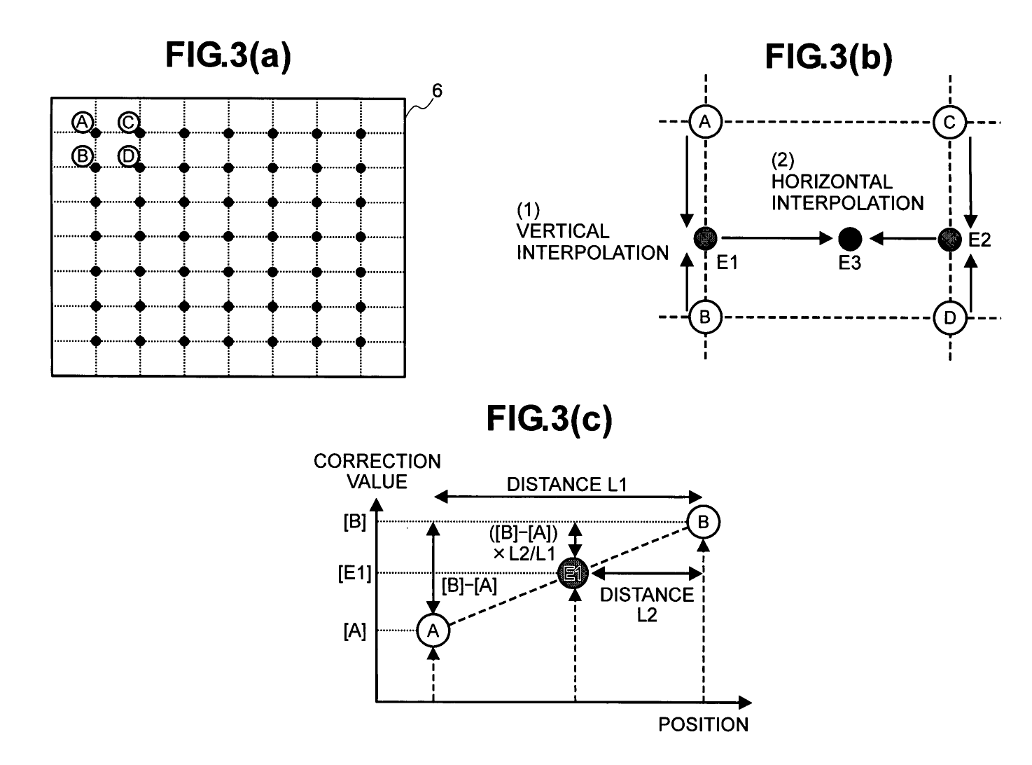

FIG. 3(a) shows a case where the display panel 6 is divided into a plural number of blocks, for example, being equally divided into eight (8) blocks, in both the horizontal direction and the vertical direction, i.e., into 64 blocks in total. Actually, though it is preferable to divide the panel further finely, however it is divided into 64 blocks, for the convenience of explanation thereof. In the present embodiment, as a method of dividing the display panel 6 into 64 blocks, for example, seven (7) imaginary horizontal lines, extending horizontally, and also seven (7) imaginary vertical lines, extending vertically, are determined on the display surface of the display panel 6. The intersecting points of those horizontal lines and the vertical lines, i.e., the positions of four corners of every blocks are determined to be correction points (i.e., black points in FIG. 3(a)). In this example, the correction points are 49, in total thereof. The imaginary horizontal and vertical lines mentioned above are determined, periodically, at every a predetermined number of the electron sources, for example. Accordingly, the correction points are determined, periodically, at a predetermined distance (or, a predetermined number). Then, measurement is made on every electron sources, of the electron emission characteristic thereof, at the positions corresponding to the correction points, and the correction values at the every correction points are calculated from those values measured. In the present embodiment, an offset value determined in advance is added to the video signals for the purpose of compensating the unevenness or dispersion of the electron emission start voltage mentioned above. For example, in FIG. 2, with the characteristic curve 1, being the electron emission characteristic of a certain electron source, an amount of electron emission I2 flows when applying the video signal D1, and I4 when applying the video signal D3.

On the other hand, with the characteristic curve 2, being the electron emission characteristic of the other electron source, an amount of electron emission I1 flows when applying the video signal D1, and I3 when applying the video signal D3. Namely, even when applying the same video signal to those electron sources, respectively, but the current values differ from each other. Then, for the purpose that current flows at the same value when applying the video signal of the same level to those electron sources, the offset amount ΔD is added in the case of the characteristic 2, so that current I2 flows when inputting the video signal D1, and also the offset amount ΔD is added, so that current I4 flows when applying the video signal D3, in the similar manner. Namely, in the present embodiment, adding the offset amount ΔD to the video signals corresponding to the other electron sources (i.e., the electron sources having the characteristic 2) brings the electron emission characteristic of the other electron sources to be equal or near to the electron emission characteristic of the above-mentioned certain electron source (i.e., the electron source(s) having the character 1).

Next, explanation will be given about a method for measuring the electron emission characteristic of the electron source, and a method for calculating the correction value, by referring to FIGS. 1 and 2. Electrons emitted from the electron source reach onto the accelerator electrode, which is positioned opposite thereto, and flow into the ground passing through the high-voltage controller circuit 9. This current corresponds to the electron emission amount shown in FIG. 2, and for detecting this, a shunt resistor 10 is inserted between the high-voltage controller circuit 9 and the ground, and thereby converting it into a voltage value. This voltage value is converted into a digital value through an A/D converter 11, to be supplied into the controller circuit 12. The controller circuit 12 is built up with a CPU, such as, a microcomputer, etc., and it converts the digital value taken therein into the electron emission amount. This measurement of the electron emission amount is carried out on all of the correction points (i.e., 49 points in the above-mentioned example). Within the controller circuit 12, a reference (hereinafter, a “reference correction point”) is selected from the correction points, and then the offset amount ΔD is calculated out for the other correction points, so that the electron emission characteristic of the other correction points be approximately coincident with the electron emission characteristic of the electron source corresponding to the reference correction point. In case when selecting the electron emission characteristic, being smallest in the electron emission start voltage, to be the reference correction point, for example, as is shown in FIG. 2, the controller circuit 12 calculates out the offset amount for bringing the other correction points to be coincident with the reference correction point in the electron emission amount. This offset amount is the correction value, each for the correction points, and this offset amount is stored into a non-volatile memory 13, such as, a flash ROM or the like, to be memorized therein. However, in the present embodiment, the A/D converter 11 is disposed outside the controller circuit 12, however this A/D converter may be built within the controller circuit 12, so as to use this built-in A/D converter.

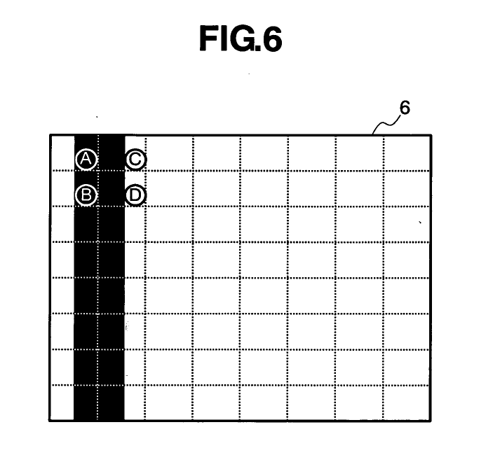

When measuring the electron emission characteristics mentioned above, in the present embodiment, a predetermined pattern is generated by means of a measuring pattern generator 83, to be displayed on the display surface of the FED panel 6. This measuring pattern generator 83 will be explained, below. With the conventional art, a dot pattern (or, a one (1) line of a vertical line pattern passing through the point “A”) is displayed, so as drive or excite only the point “A” to emit lights therefrom, when measuring the electron emission amount at a point “A” in FIG. 3(a). However, since the amount of electron emission is very small when only the point “A” emits the lights, there is a possibility that accuracy is lowered in the measurement thereof. Then, according to the present embodiment, while utilizing the characteristic therein, that the neighboring electron sources almost coincide with one another in the electron emission characteristic thereof, as was mentioned previously, i.e., a plural number of pixels are excited to emit the lights therefrom, within a region of surrounding the point “A”, but not exceeding the block, and then the amount of electron emission is measured by this unit of plural number of pixels, thereby calculating out the electron emission amount at the point “A” in an averaged value thereof. In more details, as is shown in FIG. 6, for example, a vertical line pattern is displayed so that about a half the neighboring blocks are excited to emit the lights around the point “A”. The reason of applying such line display lies in propose of also making the measurement on the other measuring points, such as, the point “B”, etc., during one (1) vertical period. When measuring on the other blocks, such as, the pint “C”, etc., the displayline is shifted, sequentially. The above-mentioned is the operation of the measuring pattern generator 83, and during the measurement of the electron emission characteristics, the display line for use in measurement is displayed while turning a switch 84 onto side of the measuring pattern generator 83. When during normal operations other than that, the switch 84 is turned onto the side of an adder 82. The generation of the measuring pattern and also the measurement of the electron emission characteristics, mentioned above, are conducted when manufacturing the FED, basically, but they may be made operable upon an instruction of a user, after shipment thereof. Or, those operations may be conducted at every constant time period when during the normal operations, so as to compensate the unevenness or dispersion in the electron emission characteristics of the respective electron sources due to changes with the passage of time.

Next, explanation will be made about a method of interpolation of the correction values. FIG. 3(b) is an enlarged view for showing the points “A”, “B”, “C” and “D”, i.e., the correction points in the left-upper block in FIG. 3(a). Referring to this FIG. 3(b), explanation will be made about a method for calculating the correction values at a position of the point E3 at a central portion of the block. It is assumed that the correction values at the points “A”, “B”, “C” and “D” are already determined upon basis of the result of measurement on the electron emission characteristics mentioned above, and that the correction values are [A], [B], [C] and [D], respectively. In the interpolation processes, first interpolation is made on a point “E1” from the points “A” and “B”, and then on a point “E2” from the points “C” and “D”, thereby achieving the interpolation in the vertical direction. Thereafter, interpolation is made on a point “E3” from the points “E1” and “E2”, and thereby achieving the interpolation in the horizontal direction. In each the interpolation method, it is conducted with applying a linear interpolation therein, for example. Explanation will be made about an equation of the linear interpolation, by referring to FIG. 3(c). Assuming that the distance between the points “A” and “B” is “L1” and that the distance between the points “B” and “E1” is “L2”, then the interpolated value [E1] at the point “E1” can be calculated out by subtracting a value, which is calculated from the difference value ([B]−[A]) at the points “A” and “B” in proportion with the distance “L2”, from [B]. An equation of the calculation can be expressed by the following equation 1:
[E1]=[B]−([B]−[A])×L2/L1 (Equation 1)

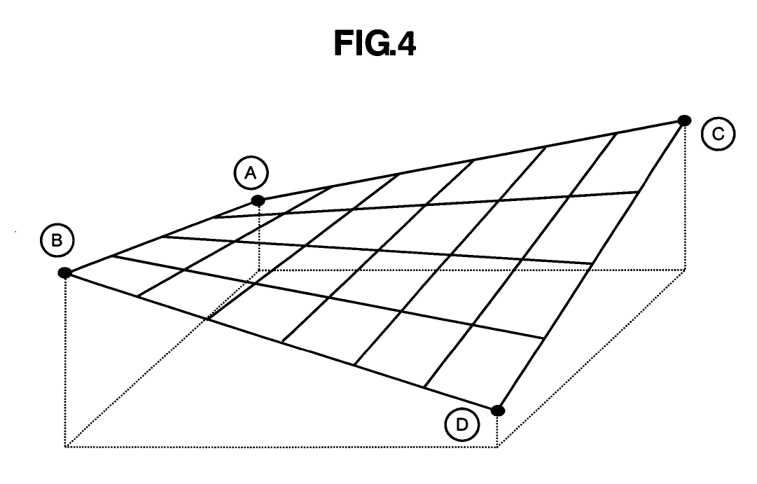

The correction value [E2] at the point “E2” can be also calculated out, in the similar method, and the correction value [E3] at the point “E3” can be, too. Through the interpolation of the correction values within the points “A”, “B”, “C” and “D”, with such the linear interpolation as mentioned above, the correction values can be plotted on a plane passing through the points “A”, “B”, “C” and “D”, as shown in FIG. 4.

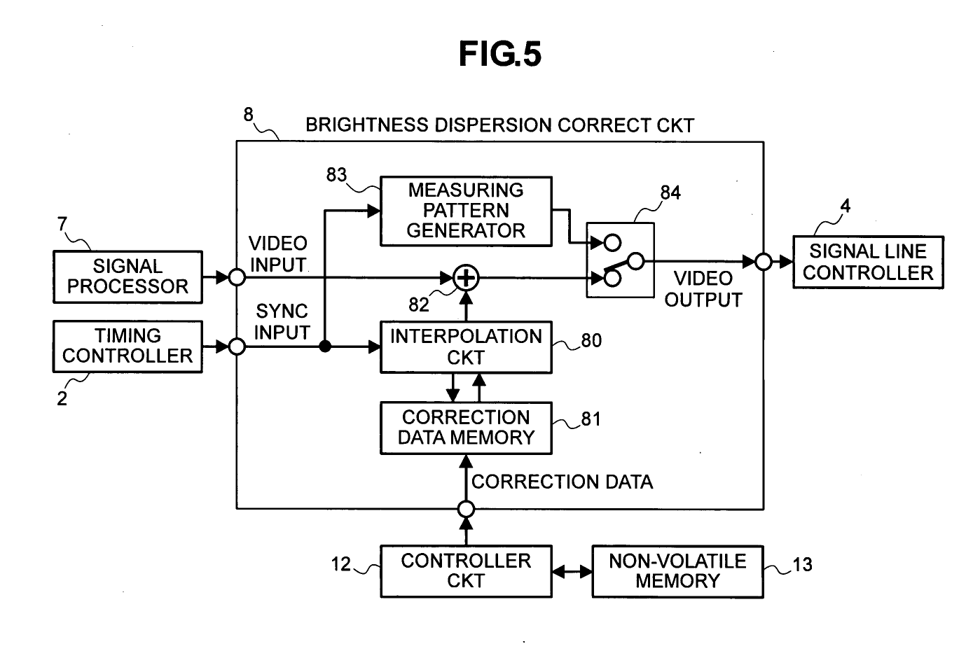

Next, explanation will be made about the details of the brightness dispersion correct circuit 8, by referring to FIG. 5. Within the block 8×8 shown in FIG. 3(a), for example, there are 7×7=49 pieces of correction points, and the 49 pieces of correction values stored in the non-volatile memory 13. During when the normal operation displaying an image thereon, the controller circuit 12 reads out the 49 pieces of correction values within the non-volatile memory 13, and transfers them to the brightness dispersion correct circuit 8. Upon receipt thereof, the brightness dispersion correct circuit 8 stores them into a memory 81 for use of correction data. This memory 81 for use of correction data may be a volatile memory, such as, a SRAM or the like, for example. An interpolation circuit 80, reading out the correction values from the memory 81 for use of correction data, executes the calculation of the equation 1, thereby conducting interpolation on the correction value corresponding to the electron source lying between the correction points. The correction value interpolated is added to the video signal through the adder 82, to be transferred to the signal line controller circuit 4.

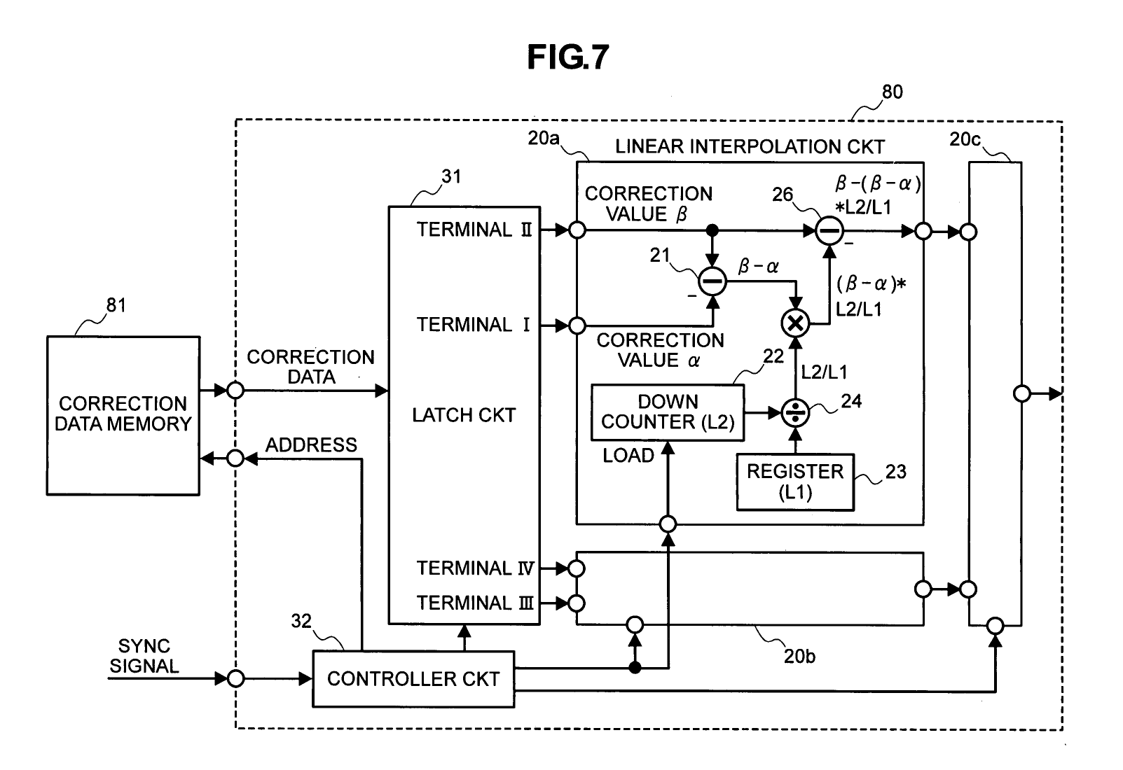

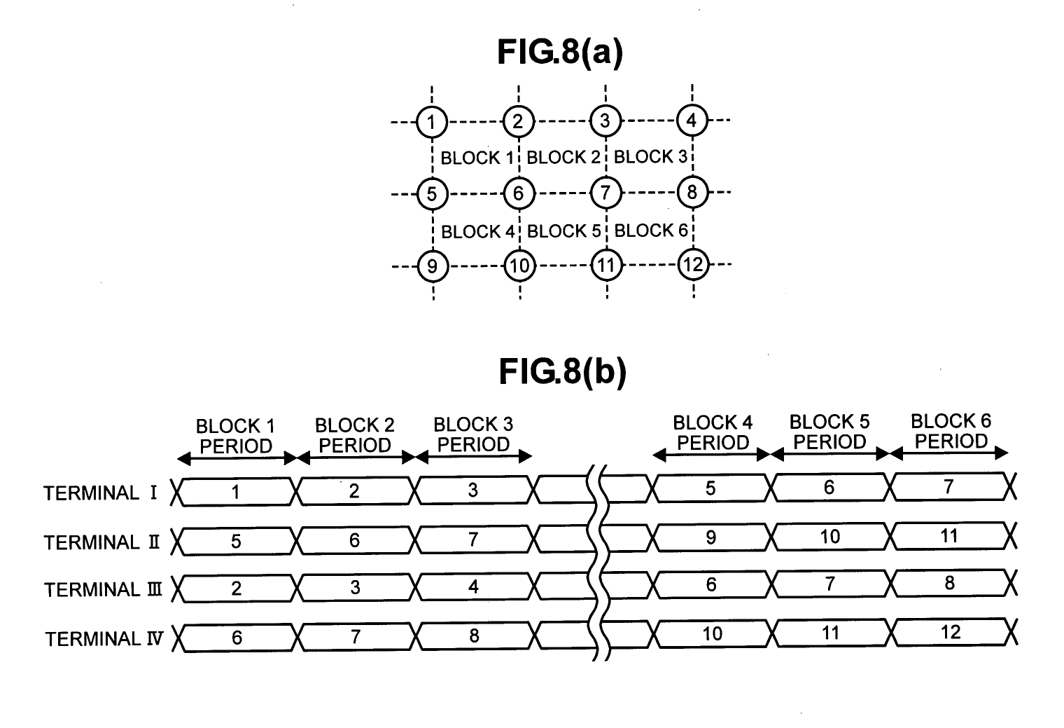

Next, explanation will be given about the details of the interpolation circuit 80, which is built within the brightness dispersion correct circuit 8, by referring to FIG. 7. This interpolation circuit 80 calculates out the interpolation value [E3] from the correction values [A], [B], [C] and [D], conducting the calculation of the equation 1 therein. The steps thereof are as follows. First of all, a controller circuit 32 generates an address signal, so as to read out the correction values [A], [B], [C] and [D] from the memory 81 for use of correction data. The correction values read out in serial are converted into parallel within a latch circuit 31, so that four (4) pieces of correction values are outputted from terminal I, II, III and IV, at the same time. Herein, explanation will be made on the operation of the latch circuit 31, by referring to FIGS. 8(a) and 8(b). FIG. 8(a) shows six (6) pieces of the blocks, therefore there are correction values at every corner thereof; i.e., 12 pieces in total thereof. FIG. 8(b) shows a manner of selecting the four (4) correction values in each of the blocks, thereby to be outputted, simultaneously. In a case where a video signal is in the period of the block 1, for example, the correction values [1], [5], [2] and [6] are outputted, simultaneously, after being read out. In the block 2, the correction values [2], [6], [3] and [7] are outputted, simultaneously, after being read out, in the similar manner. Hereinafter, the similar operation will be repeated. The four (4) corrections values outputted from the latch circuit 31 are outputted; i.e., the outputs at the terminals I and II are to a linear interpolation circuit 20a, and the outputs at the terminals III and IV to a linear interpolation circuit 20b, respectively. However, there are three (3) pieces of the interpolation circuits in the present embodiment, but they are same in the circuit constructions thereof. For this reason, the inner structures of those linear interpolation circuits 20b and 20c are omitted, herein. Explanation will be made on a concrete example of the linear interpolation circuit 20a, hereinafter.

The linear interpolation circuit 20a executes the calculation of the equation 1 therein, thereby calculating out the correction values between the respective correction points. First, it inputs the correction value “α” at the terminal I, and the correction value “β” at the terminal II, and it obtains (α−β) by means of a subtractor 21. On the other hand, assuming that the distance between “α” and “β” is “L1” and the distance between “β” and the correction point is “L2”, it calculates out (L1/L2) by means of a divider 24. Herein, “L1” is, in more details thereof, a number of lines included in one (1) side in the vertical direction of one (1) block (or, the number of pixels included in one (1) side in the horizontal direction of one (1) block in the linear interpolation circuit 20c), and is stored in advance within a register 23. Also, “L2” is variable depending on the position of the interpolation point. Thus, if the interpolation point is at a point “α”, L2=L1, while being subtracted by one (1) every time when separating from by one (1) line, and when it reaches to a point “β”, L2=0. This value of “L2” is generated within a down counter 22. This operation is shown in FIG. 9. When a load signal is inputted from the controller circuit 32, the down counter 22 outputs the value “L1”, and thereafter, it is decremented by one (1), thereby counting down to zero (0). Thereafter, the load signal is inputted, again, and then the down counter 22 outputs the value “L1” and conducts the countdown operation. Thereafter, it repeats this operation. Next, (β−α) and (L2/L1) obtained above are multiplied with in a multiplier 25, thereby obtaining (β−α)×(L2/L1), and this is inputted into a subtractor 26, thereby obtaining β−(β−α)×(L2/L1) (or, the interpolation value in the horizontal direction in the linear interpolation circuit 20c). With such the operation mentioned above, the correction values are calculated out for all of the lines of the electron sources, which are included between the correction points “A” and “B”, through the interpolation.

Within the linear interpolation circuit 20b, the similar operation is conducted, and the correction values for the electron sources of all lines, which are included between the correction points “C” and “D”, through the interpolation. Therefore, the two (2) pieces of interpolation values in the vertical direction (i. e., the correction values at the points “E1” and “E2” in FIG. 3) can be obtained from the outputs of the linear interpolation circuits 20a and 20b. Within the linear interpolation circuit 20c, the interpolation calculation similar to the above is conducted, so as to obtain the interpolation value in the horizontal direction from those two (2) pieces of interpolation values (i.e., the correction values at the points “E1” and “E2”; thereby calculating out the interpolation value at a final signal position.

Wit the operations mentioned above, the correction values can be obtained for all of the electron sources, which are included within the block enclosed or defined by the pints at the four (4) corners, i.e., the points “A” to “D”. However, in case when obtaining the correction value corresponding to the electron source, which is located on a straight line connecting between the points “A” and “B”, and also the correction value corresponding to the electron source, which is located on a straight line connecting between the points “C” and “D”, the register value and/or the counter value within the linear interpolation circuit 20c are selected in such a manner that the output of the linear interpolation circuit 20c comes to be equal to that of the interpolation circuit 20a or 20b. However, in the explanation mentioned above, no explanation was given, in particular, about calculation of the correction values corresponding to the electron sources, which are located between the correction point, which is located outermost among 49 pieces of correction points, and the outermost periphery of the display surface of the FED panel 6. However, it is preferable to obtain the correction value corresponding to the electron source locating at that point, in the similar manner. In this instance, the correction points may be determined at the electron sources locating at both ends, the left-hand and the right-hand sides, on the imaginary horizontal line mentioned above, and the electron sources locating at both ends, the up and down sides, on the imaginary vertical line mentioned above. And, in the manner similar to the above, the interpolation calculations are executed with using the correction points locating at the end portions of those lines.

Herein, summary of the operations in correction of the video signal, according to the present embodiment, is as follows:

(1) determine the correction points by dividing the display surface of the FED panel 6 into the plural number of blocks;

(2) display measurement pattern, and measure the amount of electron emission at the correction points determined;

(3) select a specific one among the correction points, as a reference correction point, and calculate the correction value (i.e., the offset value) corresponding to other correction points upon basis of the amount of electron emission of the electron source corresponding to that reference correction point, and set it (i.e., memorized into the memory); and

(4) calculate the correction values through interpolation, corresponding to the electron sources other than the above-mentioned correction point, with using the correction values set in the above.

The steps (1) to (3) mentioned above are conducted during when manufacturing the apparatus or before shipping it from works, as was mentioned above, and the (4) is conducted during when it is in the normal operation. However, the above steps (1) to (3) may be executed after the shipment from works, for example, during when it is in the normal operation.

In this manner, according to the present embodiment, the interpolation value can be obtained from the correction values, obtained by divining into the plural number of blocks, and therefore correction can be made on the brightness dispersion with a small number of correction values and within measurement of short time period.

However, though the linear interpolation is applied in the present embodiment, but other non-linear interpolations may be applied in the place thereof, for example, the spline interpolation, the Lagrange interpolation, etc. Also, the explanation was given about the case of 8×8 blocks, in the present embodiment, but it may be other than that. Preferably, the number of clocks be equal 10×10 or more, or preferably, to be equal to a half (½) of the total number of pixels in the horizontal and the vertical directions to lower than that (thus, the correction point is determined at every other (or second) electron source.

### Embodiment 2

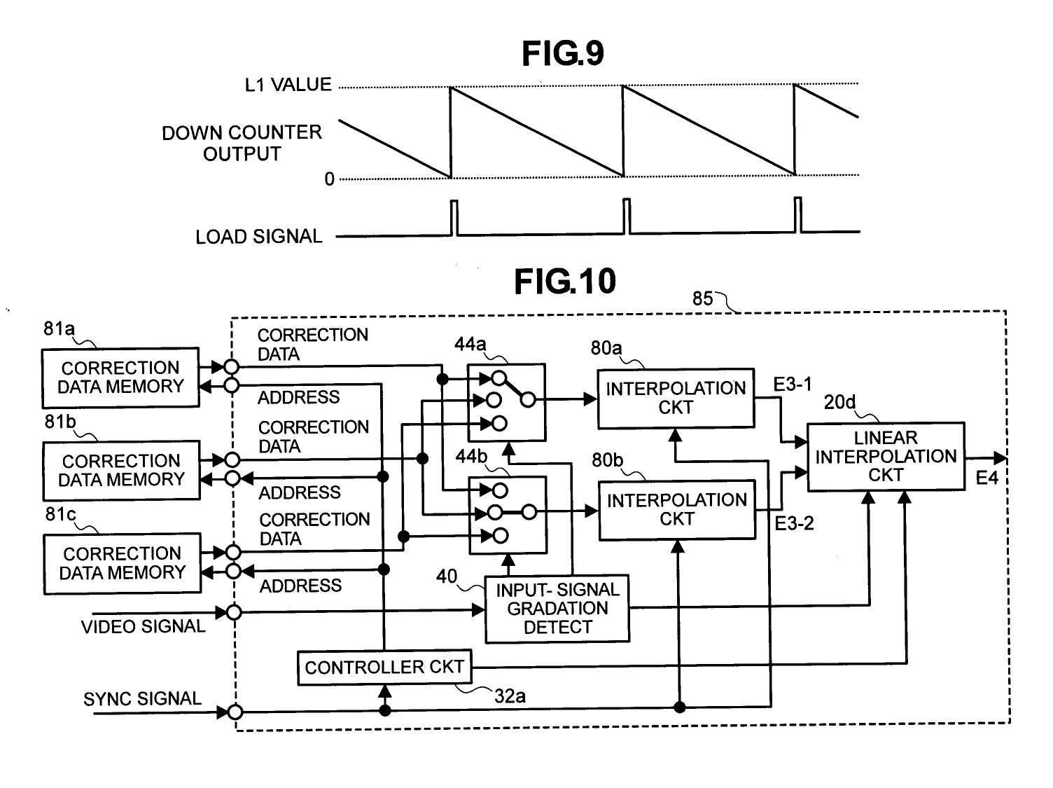

Next, explanation will be given about a second embodiment of the FED-type image displaying apparatus, according to the present invention. FIG. 10 is a block diagram for showing the interpolation circuit 85, for showing the second embodiment according to the present invention, and within the interpolation circuit 85 shown in this FIG. 10, the elements attached with the reference numerals, being same to those shown in FIGS. 5 and 7 according to the first embodiment, have the same functions thereof. An aspect of the second embodiment differing from the first embodiment shown in FIGS. 5 and 7 lies in that there are provided a plural number of the memories for use of correction data, corresponding to a plural number of predetermined gradations, and accompanying this, there are also provided a plural number of the interpolation circuits. With this, the correction data can be changed depending on the gradation of the video signal, and thereby correcting the brightness dispersion with preferable or superior accuracy.

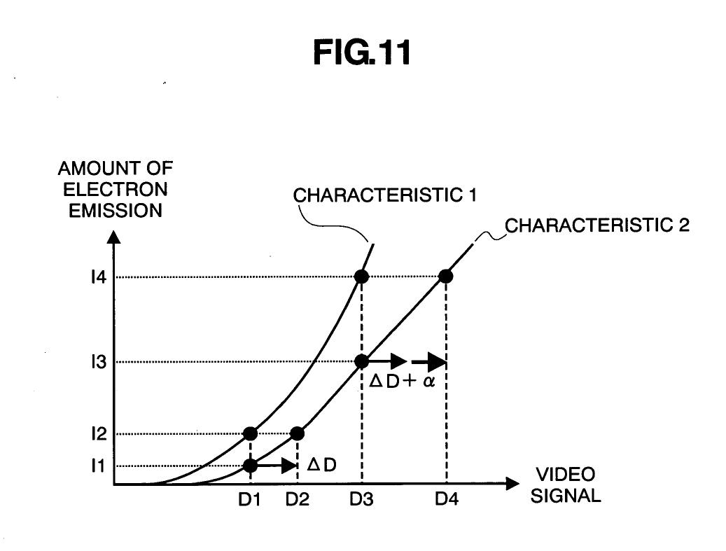

First, explanation will be made on an outlook of operations of the second embodiment. FIG. 11 shows the characteristics of the two (2) pieces of the electron sources located at the positions differing from each other, in relation to an amount of electron discharge to the video signal, wherein a characteristic 1 and a characteristic 2 differ from each other, in particular, in the electron emission start voltage, due to the unevenness or dispersion of the element characteristics thereof. Also, the characteristic 1 and the characteristic 2 differ from each other, in a rate of increasing of the amount of electron emission with respect to change of the signal level higher than the electron emission start voltage. Herein, the characteristic 1 is lower than the characteristic 2 in the increasing rate of the amount of electron emission. For this reason, it is impossible to obtain the current similar to that of the characteristic 1, even if adding the same offset value “ΔD” for the electron sources having the characteristic 2 shown in FIG. 11, in all of the gradations thereof. Accordingly, it is possible to obtain the desired value I4 of current flow by adding “ΔD+α” at D3, for example. This is because the element characteristics of two (2) electron sources cause the differences, not only the difference in the electron emission start voltage, simply, but also the difference in the element characteristic in the gradation higher than a middle graduation, i.e., the increasing rate of the mount of electron emission mentioned above.

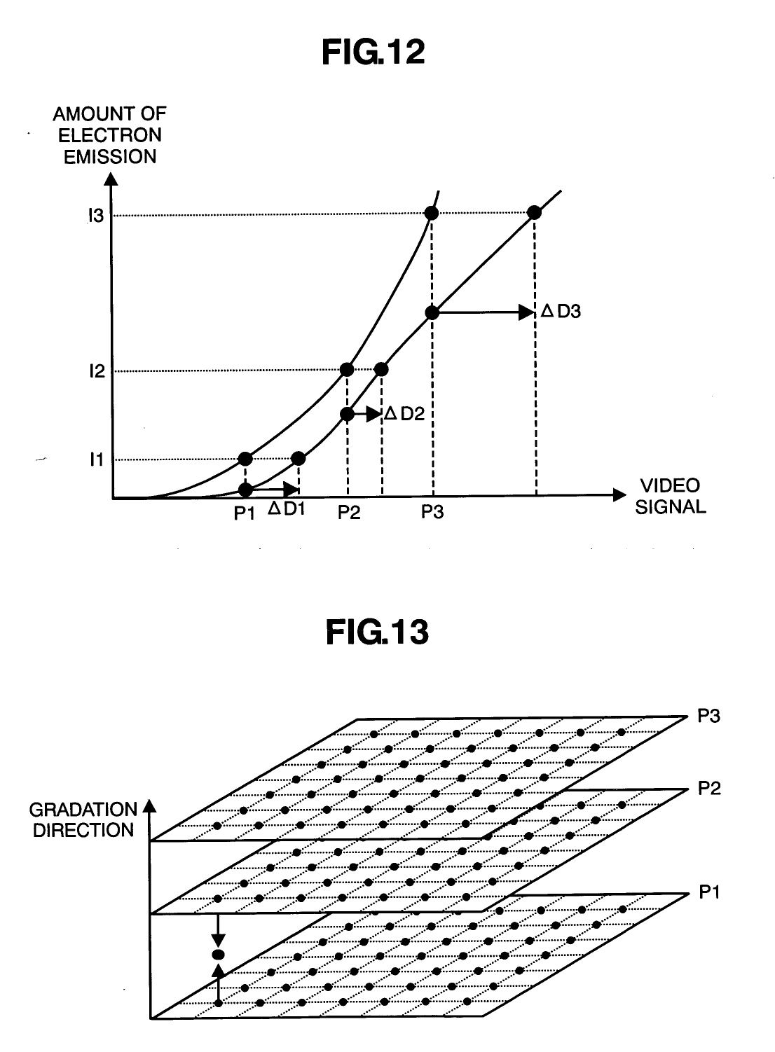

Then, according to the present invention, the correction values are provided at plural points for each of a plural number of predetermined gradations, and the optimal correction values at the plural points are calculated through measurement, while producing the correction values corresponding to the gradations between them through the interpolation. Explanation will be made about this concept, further in more details thereof, by referring to FIGS. 12 and 13. In FIG. 12, measurement is made of the element characteristics at three (3) points, i.e., low gradation, middle gradation, and high gradation (“P1”, “P2” and “P3”, respectively), and the “P1”, “P2” and “P3” have correction values thereof, respectively. And, by adding “ΔD1” at the “P1”, ΔD2” at the “P2”, and ΔD3” at the “P3”, it is possible to bring the electron emission characteristic to be nearly between the two (2) electron sources. The correction values between the “P1”, “P2” and “P3” can be obtained through the interpolation calculation, with using the respective correction values, which are determined at “P1”, “P2” and “P3”, respectively. FIG. 13 is a view for showing the gradation direction and a concept of interpolation of a surface-space block division. The interpolation in the surface-space, in the similar manner to that of the first embodiment, the correction points are determined or set for each of the plural number of blocks, and interpolation is made between them. This surface-space exists at three (3) points, i.e., the low gradation, the middle gradation, and the high gradation, and they correspond to the three (3) gradations, “P1”, P2” and “P3”. The interpolation in the direction of gradation is also calculated by a method similar to that of the interpolation between blocks in the surface-space. The above is the outlook of the operations in the present embodiment.

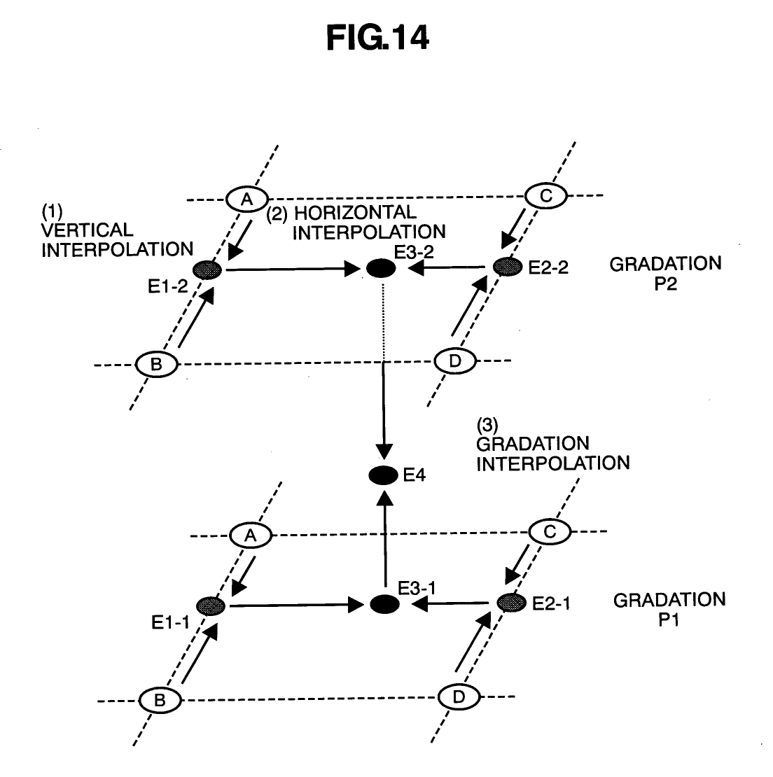

Next, the detailed operations in the present embodiment will be explained, by referring to FIGS. 10 and 14 attached herewith. FIG. 14 is a view for explaining the interpolation method in the direction of gradation, in the present embodiment. It is assumed that a level of the video signal inputted lies between “P1” and “P2”, for example, while the correction points in the gradation direction are “P1”, “P2” and “P3”, in the similar manner to that shown in FIG. 12. Though the interpolation method on the surface of each of the gradations “P1” and “P2” is omitted, since it is same to that of the embodiment 1, but correction values “E3−1” and “E3−2” are calculated, respectively, at every gradation. The interpolation value “E−4” between “E3−1” and “E3−2” can be calculated, from the distance between “P1” and “P2” (herein, the levels of the video signals), in the similar manner to that of the vertical and horizontal interpolation methods in the first embodiment.

A concrete example of the correct circuit is shown in FIG. 10, for executing the interpolation calculation explained in FIG. 14. In this FIG. 10, a correction data memory 81a corresponds to the gradation “P1”, a correction data memory 81b to the gradation “P2”, and a correction data memory 81c to the gradation “P3”, respectively. An input-signal gradation detect circuit 40 detects the gradation of the video signal inputted, and determines on where it lies between “P1” to “P3”. In case where the gradation of the video signal lies between “P1” and “P2”, for example, a switch circuit 81a selects the correction data memory 81a, while a switch circuit 81b selects the correction data memory 81b, thereby transmitting them to interpolation circuits 80a and 80b, respectively. Though operations of the interpolation circuits 80a and 80b are omitted herein since they are same to those explained in the embodiment 1, but each of them conducts the interpolation between the blocks within the surface on the gradation “P1” or “P2”, and therefore, they output the interpolation values “E3−1” and “E3−2” shown in FIG. 14. From those interpolation values “E3−1” and “E3−2”, a further interpolation value “E4” is produced within a linear interpolation circuit 20d. This linear interpolation circuit 20d is almost similar to that of the linear interpolation circuit 20 in the first embodiment, but differs from it, in an aspect. Thus, it is in that the linear interpolation circuit 20d is supplied from the input-signal gradation detect circuit 40, with distance information for calculating the gradation level of the inputted video signal from two (2) pieces of correction values, i.e., the correction value depending upon the distances from the gradations “P1” and “P2”.

With such the structures as mentioned above, it is possible to correct the brightness dispersion, with superior or preferable accuracy, even in the direction of gradation. Namely, according to the present embodiment, it is also possible to compensate the unevenness or dispersion in the increasing rate of the amount of electron emission in region from the middle up to the high gradation, preferably, but other than the unevenness or dispersion in the electron emission start voltage between the different electron sources. However, though the number of the correction points is three (3) in the present embodiment, but it may be other than that.

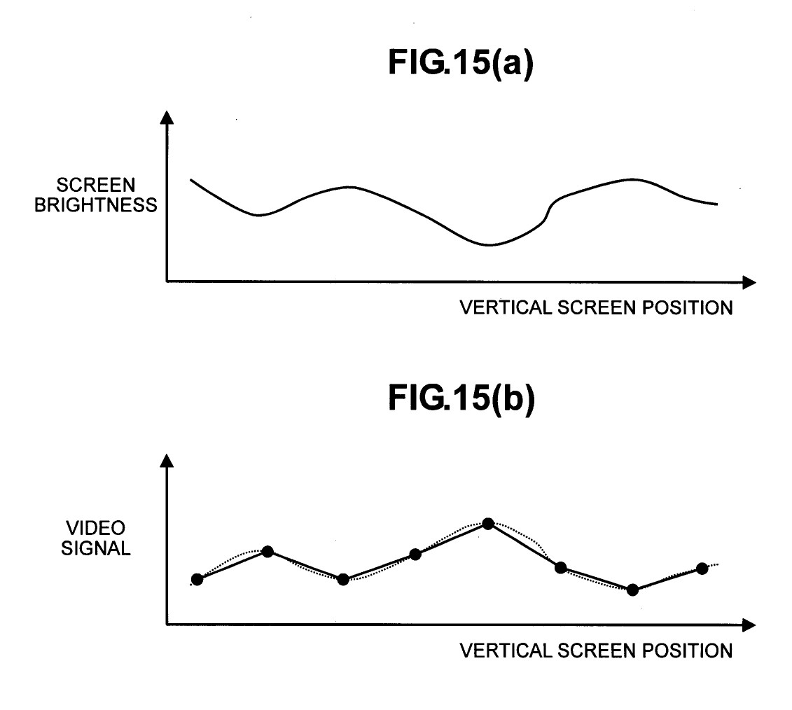

FIGS. 15(a) and 15(b) show examples of the video signals, after being added with the correction values in the embodiments 1 and 2, respectively. FIG. 15(a) is a view of plotting the screen brightness in the vertical direction in case of conducting no dispersion correction thereon, in particular, when inputting a constant video signal, and it indicates that the unevenness like a swell is in the brightness thereof. Contrary to the unevenness in brightness shown in FIG. 15(a), FIG. 15(b) shows the video signal after adding the correction values by applying the present embodiment therein. A dotted line in this FIG. 15(b) is an ideal video signal after being corrected, and it has a characteristic in reverse to the unevenness of brightness. Black points in this FIG. 15(b) depict the correction values in the present embodiment, and a solid line therein depicts the interpolation values between the correction values. In this manner, the video signal after being added with the correction values comes to be a polygonal line having break points at the correction points, i.e., have a waveform like a graph of broken lines.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. An image displaying apparatus, comprising:
a plural number of electron sources, being disposed in matrix-like manner, each for emitting electrons therefrom;
a driver for producing drive voltage for driving said electron sources upon basis of a video signal, to be supplied to said electron sources; and
a correct circuit for correcting said video signal,
wherein said correct circuit determines a predetermined number of correction points in horizontal and vertical directions, for said plural number of electron sources disposed in the matrix-like manner,
corrects the video signal to the electron source corresponding to said correction point upon basis of a first correction value, which is determined in advance, and
corrects the video signal corresponding to the electron source located between said correction points, upon basis of a second correction value, which is obtained through an interpolation calculation with using said first correction values, which are determined at each of the correction points.

2. The image displaying apparatus, as described in the claim 1, wherein said correct circuit includes a memory portion for memorizing said first correction value therein, and a calculation portion for calculating said second correction value.

3. The image displaying apparatus, as described in the claim 2, wherein said calculation portion calculates out said second correction value through a linear interpolation calculation of at least two (2) pieces of said first correction values.

4. The image displaying apparatus, as described in the claim 2, wherein said calculation portion calculates out said second correction value through a non-linear interpolation calculation of at least two (2) pieces of said first correction values.

5. The image displaying apparatus, as described in the claim 1, wherein said correction points are determined in the horizontal and the vertical directions, being equal to ten (10) pieces thereof or more.

6. The image displaying apparatus, as described in the claim 1, wherein said first correction value includes data for compensating at least unevenness in electron emission start voltage of the electron source, which is determined to be said correction point.

7. The image displaying apparatus, as described in the claim 1, wherein at least one of said plural number of correction points is determined to be a reference correction point, and an offset value depending on a difference between the electron emission start voltage of the electron source corresponding to said reference correction point and the electron emission start voltage of the electron source corresponding to the correction point other than said reference correction point is determined to be said first correction value at the correction points other than said reference correction point.

8. The image displaying apparatus, as described in the claim 1, wherein a number of said correction points is equal to seven (7) or more in the horizontal direction, while being equal to or less than a half (½) of a total number of the electron sources in the horizontal direction, and a number of said correction pints is equal to seven (8) or more in the vertical direction, while being equal to a half (½) of a total number of the electron sources in the vertical direction.

9. An image displaying apparatus, comprising:
a plural number of scanning lines;
a scanning line controller circuit, connected at either one ends of said plural number of scanning lines, for supplying scanning voltages to said plural number of scanning lines, sequentially;
a plural number of signal lines;
a signal line controller circuit, connected with said plural number of signal lines, for supplying driving voltages depending on the video signal inputted, to said plural number of signal lines;
electron sources, connected at intersecting portions of said plural number of scanning lines and said plural number of signal lines intersect, respectively, and each for emitting electrons depending on potential difference between said scanning voltage and said driving voltage; and
a correct circuit for correcting said video signal,
wherein a display region of said image displaying apparatus is divided into a plural number of blocks, and said correct circuit corrects the video signals corresponding to the electron source located at four (4) corners of each of said blocks upon basis of a predetermined correction value, which is memorized in advance, and corrects the video signals corresponding to the electron source locating other than said four (4) corners by a correction value, which is obtained through calculation of said correction value.

10. The image displaying apparatus, as described in the claim 9, wherein said correct circuit calculates a correction amount of the video signal corresponding to each of the electron sources located within the block, from the correction values corresponding to the four (4) corners of the each block, through an interpolation thereof.

11. The image displaying apparatus, as described in the claim 9, wherein said correct circuit holds said correction value for each of plural gradations predetermined.

12. The image displaying apparatus, as described in the claim 9, wherein said correct circuit calculates the correction value between said predetermined gradations through an interpolation.

13. The image displaying apparatus, as described in the claim 9, wherein said correct circuit measures voltage-current characteristics of the plural number electron sources, which are neighboring with at the four (4) corners of said each block, and calculates the correction amounts at the four (4) corners of said each block in a form of an averaged value thereof.

14. An image displaying apparatus, comprising:
a plural number of electron sources, being disposed in matrix-like manner, each for emitting electrons therefrom;
a driver for producing drive voltage for driving said electron sources upon basis of a video signal, to be supplied to said electron sources; and
a correct circuit for correcting said video signal, wherein said correct circuit determines a predetermined number of correction points in horizontal and vertical directions, for said plural number of electron sources disposed in the matrix-like manner, and
said video signal is so corrected that at least one (1) column of the video signal in the vertical direction outputted from said correct circuit has a shape of a broken line having breaking points at said predetermined number of correction points, when a video signal having a constant graduation for one (1) piece of a screen is inputted as said video signal.

15. The image displaying apparatus, as described in the claim 14, wherein said video signal is so corrected that at least one (1) line of the video signal in the horizontal direction outputted from said correct circuit has a shape of a broken line having breaking points at N pieces of the correction points, when a video signal having a constant graduation for one (1) piece of a screen is inputted as said video signal.
